(19) United States
(12) Patent Application Publication
(10) Pub. No.: US 2012/0034795 A1
(43) Pub. Date: Feb. 9, 2012

(54) Electronic Apparatus and Wrong Insertion Prevention Member

(76) Inventors: Kenji Nitobe, Hamura-shi (JP); Akira Sugiyama, Suginami-ku (JP)

(21) Appl. No.: 13/093,626

(22) Filed: Apr. 25, 2011

(30) Foreign Application Priority Data
Aug. 9, 2010 (JP) 2010-178587

(51) Int. Cl. H01R 13/447; H01R 13/44

(52) U.S. Cl. 439/142; 439/136

(57) ABSTRACT

According to one embodiment, an electronic apparatus includes: a plurality of jacks, for which an order of priority in plug insertion is set, including a first jack of low priority and a second jack of high priority; and a wrong insertion prevention member, provided on the periphery of jacks, configured to close at least a part of the first jack when no plug is connected to the second jack, and configured to disclose the first jack when a plug is inserted in the second jack.

### CROSS REFERENCE TO RELATED APPLICATION(S)

The application is based upon and claims the benefit of priority from Japanese Patent Application No. 2010-178587 filed on Aug. 9, 2010, the entire contents of which are incorporated herein by reference.

### BACKGROUND

1. Field

An embodiment of the present invention relates to an electronic apparatus having a modular jack and a modular jack wrong insertion prevention member.

2. Description of the Related Art

Generally, for a telephone, a handset having a telephone transmitter and a telephone receiver is used for making a call. The handset is connected to the telephone main unit through a modular jack. Moreover, there are members other than the handset that are connected to the telephone main unit through a modular jack.

In many cases, these modular jacks have the same shape, and as for the positions of the modular jacks, it is often the case that a plurality of modular jacks are placed in a line for convenience of layout.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is an external view of a telephone of an embodiment;

FIG. 2 is a structural view showing the structure of modular jacks of a telephone main unit;

FIG. 3 is a structural view of a modular jack portion of an example of the present proposal where a wrong insertion prevention member is provided;

FIG. 4 is a view showing the shape of the wrong insertion prevention member of the embodiment;

FIG. 5 is a cross-sectional view taken along A-A of FIG. 3;

FIG. 6 is a structural view viewed from the inside of the telephone main unit;

FIG. 7 is a structural view of a spring used for the wrong insertion prevention member;

FIG. 8 is a cross-sectional view for explaining an attachment structure for the wrong insertion prevention member;

FIG. 9 is a structural view of a retaining ring used for the wrong insertion prevention member;

FIG. 10 is a view showing a condition before a “high” priority modular plug of the embodiment is inserted;

FIG. 11 is a view showing a condition after the “high” priority modular plug of the embodiment is inserted;

FIG. 12 is a view showing a case where a modular plug is being inserted into a wrong modular jack in the embodiment; and

FIG. 13 is a cross-sectional view showing the case of the wrong insertion in the embodiment.

### DETAILED DESCRIPTION

Hereinafter, an embodiment will be described in detail with reference to the drawings.

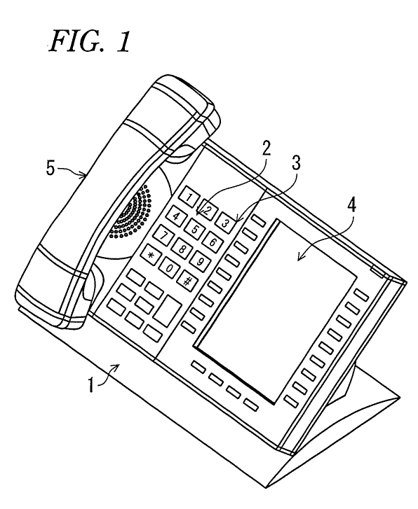

FIG. 1 is an external view of a telephone as an example of the present proposal.

A telephone main unit 1 is provided with dial keys 2, function keys 3, a display section 4, a handset 5 and the like.

To make a call with a telephone, generally, the handset 5 having a telephone transmitter and a telephone receiver is lifted and a call is originated by dialing, thereby making a call. However, for example, when it is assumed that operators intensively receive telephone calls as in a call center, a case is also considered where operators respond with a headset having a microphone and a speaker to ensure operators' workability. For this reason, in many cases, the telephone main unit has not only a modular jack for a handset but also a modular jack for a headset.

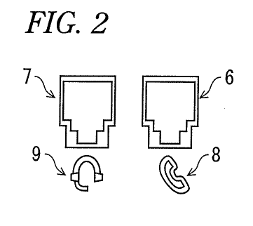

FIG. 2 is a view showing the structure of the modular jacks of the telephone main unit 1.

A modular jack 6 for a handset and a modular jack 7 for a headset are provided on the back surface or the like of the telephone main unit 1. In many cases, the shapes and sizes of modular jacks are the same. Therefore, to prevent modular plug wrong insertion, a handset mark 8 is engraved (or printed) on a peripheral part of the handset modular jack 6, and a headset mark 9 is engraved (or printed) on a peripheral part of the headset modular jack 7.

However, by a method of distinguishing between the modular jacks only by indication marks, there is a possibility that a modular plug is erroneously inserted into a wrong modular jack. Specifically, with a current telephone, if the modular plug of the handset is inserted into the headset modular jack 7, a malfunction occurs such that the telephone cannot be made off the hook. Therefore, for the two kinds of modular jacks, not only it is necessary not to insert the modular plugs into the wrong modular jacks but also the order of priority is defined for the order in which the modular plugs are inserted. For this reason, first, a handset modular plug which is first in the order of priority is inserted into the handset modular jack 6 which is first in the order of priority. Then, a headset modular plug which is second in the order of priority is inserted into the headset modular jack which is second in the order of priority.

For this reason, in the present example, a wrong insertion prevention member 10 is provided so that the handset modular plug is inserted into the handset modular jack with reliability.

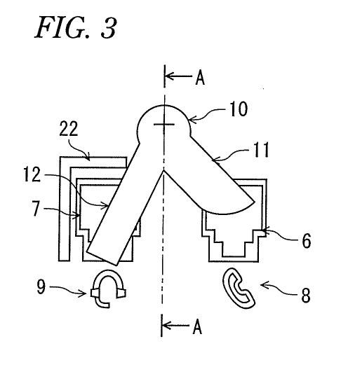

FIG. 3 is a structural view of the modular jack portion of the example of the present proposal where the wrong insertion prevention member 10 is provided.

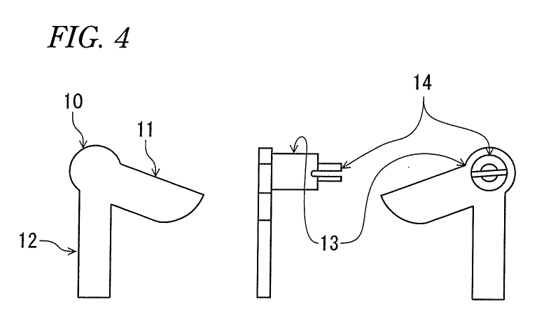

In the figure, the wrong insertion prevention member 10 is rotatably attached to a peripheral part of the handset modular jack 6 and the headset modular jack 7 provided on the telephone main unit 1. As shown in FIG. 4, the wrong insertion prevention member 10 is L-shaped, and has a short leg portion 11 on the side of the (handset) modular jack which is first in the order of priority and has a long leg portion 12 on the side of the (headset) modular jack which is second in the order of priority. The long leg portion 13 is partly arc-shaped. The L-shaped wrong insertion prevention member 10 is attached so as to close the two modular jacks.

A rotation axis 13 is provided on the back surface of the part of connection between the short leg portion 11 and the long leg portion 12, and a slid 14 is provided on the end thereof.

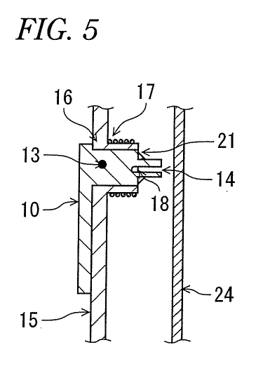

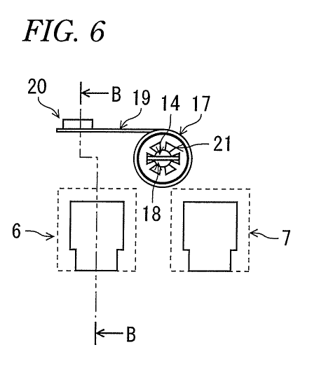

FIG. 5 is a cross-sectional view taken along A-A of FIG. 3. FIG. 6 is a view viewed from the inside of the telephone main unit 1.

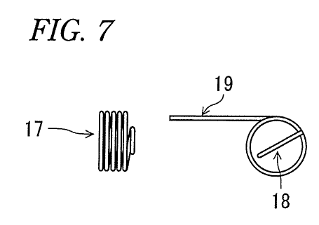

A main unit base 15 has a hole, and an extension nib 16 that extends the depth of the hole is provided. The rotation axis 13 of the wrong insertion prevention member 10 is inserted into the hole of the main unit base 15, and a spring 17 is attached. FIG. 7 is a view showing the shape of the spring 17.

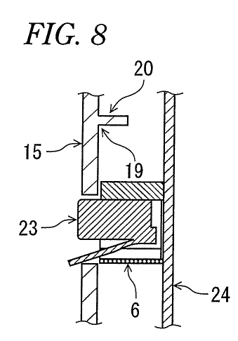

FIG. 8 is a longitudinal cross-sectional view (cross-sectional view taken along B-B of FIG. 6) of a spring stop rib 20 of the example of the present proposal.

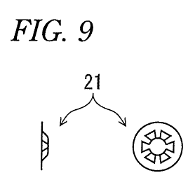

An end 18 of the spring 17 is inserted into the slid 14 provided on the rotation axis 13, and the other end 19 of the spring is hitched to the spring stop rib 20 of the main unit base 15 to be fixed. Further, a retaining ring 21 shown in FIG. 9 is pressed onto the rotation axis 13 in order to prevent the spring 17 from falling off the rotation axis 13 and prevent the wrong insertion prevention member 10 from falling off the main unit base 15.

By being attached by using the spring 17 as described above, the wrong insertion prevention member 10 is provided with a turning force in the clockwise direction in FIG. 3. On the two sides of the periphery of the headset modular jack 7 which is second in the order of priority, a wrong insertion prevention rib 22 is provided. The wrong insertion prevention rib 22 serves also as the rotation stopper of the wrong insertion prevention member 10.

Next, the operation will be described.

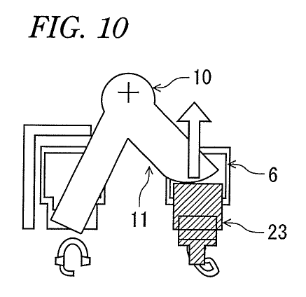

FIG. 10 is a view showing a condition of the wrong insertion prevention member 10 when a handset modular plug 23 which is first in the order of priority is inserted.

When the modular plug 23 is inserted into the handset modular jack 6, a side surface of the long leg portion 12 is pressed against a side surface of the short leg portion 11 of the wrong insertion prevention member 10, and the modular plug 23 is moved in the direction shown by the arrow to be inserted.

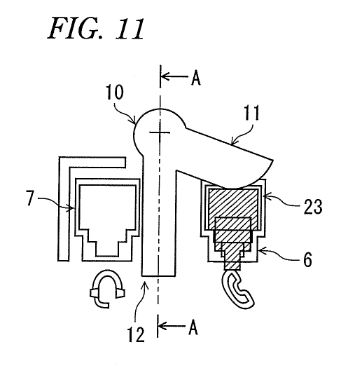

FIG. 11 is a view showing a condition of the wrong insertion prevention member 10 after the handset modular plug 23 which is first in the order of priority is inserted.

When the modular plug 23 is inserted into the handset modular jack 6, the wrong insertion prevention member 10 is rotated and this causes the long leg portion 12 to move off the headset modular jack 7, so that the headset modular plug is insertable.

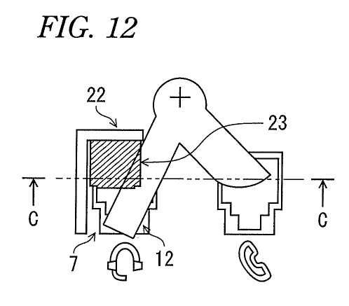

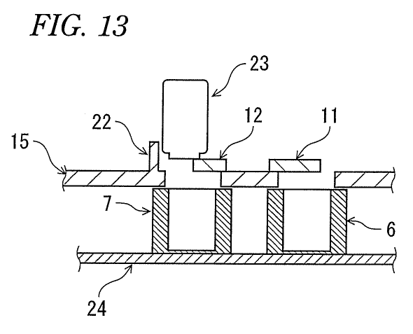

On the other hand, FIG. 12 is a view showing a case where a modular plug is being inserted into a wrong modular jack, and FIG. 13 is a cross-sectional view taken along C-C of FIG. 12.

As already described, the wrong insertion prevention member 10 receives a clockwise force by the working of the spring 17, and the wrong insertion prevention rib 22 acts as the rotation stopper. For this reason, even if it is attempted to insert the modular plug 23 first into the headset modular jack 7 which is second in the order of priority, since the headset modular jack 7 is closed by the long leg portion 12 of the wrong insertion prevention member 10 and the wrong insertion prevention rib 22 set on the main unit base 15, insertion of the modular plug 23 is blocked. The handset modular jack 6 and the headset modular jack 7 are fixed onto a substrate 24.

As described above, in the present embodiment, unless the handset modular plug 23 is inserted into the handset modular jack 6 first, the long leg portion 12 of the wrong insertion prevention member 10 closes the headset modular jack 7, so that the possibility of wrong insertion of a handset modular plug into the headset modular jack 7 is physically eliminated. Consequently, malfunction of the telephone due to a wrong insertion of a modular plug can be prevented.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a plurality of jacks, for which an order of priority in plug insertion is set, including a first jack of low priority and a second jack of high priority; and
a wrong insertion prevention member, provided on the periphery of jacks, configured to close at least a part of the first jack when no plug is connected to the second jack, and configured to disclose the first jack when a plug is inserted in the second jack.

2. The electronic apparatus according to claim 1, wherein
the wrong insertion prevention member is attached in a neighborhood of the periphery of jacks so as to be rotatable about an axis, the wrong insertion prevention member having a short leg portion on a side of the second jack and a long leg portion on a side of the first jack.

3. The electronic apparatus according to claim 1, wherein
the wrong insertion prevention member has an elastic member configured to rotate a long leg portion of the wrong insertion prevention member in a direction that closes the first jack.

4. The electronic apparatus according to claim 1, wherein
the first jack has a wrong insertion prevention rib provided on two sides on a periphery of the first jack.

5. The electronic apparatus according to claim 1, wherein
the electronic apparatus is a telephone,
the second jack is a modular jack for a handset; and
the first jack is a modular jack for a headset.

6. A wrong insertion prevention member attached to a neighborhood of a plurality of jacks provided on an electronic apparatus so as to be rotatable about an axis, the wrong insertion prevention member comprising:
a short leg portion on a side of a modular jack of high priority; and
a long leg portion on a side of a modular jack of low priority.
